(19) United States
(12) Patent Application Publication
(10) Pub. No.: US 2017/0342941 A1
(43) Pub. Date: Nov. 30, 2017

(54) INTEGRATED THRUST REVERSER ACTUATION SYSTEM

(71) Applicant: MRA Systems, LLC, Baltimore, MD (US)

(72) Inventors: John S. MEARS, Cincinnati, OH (US); Stephen Charles HANAK, Middletown, OH (US); George Stephen BILLISITS, West Chester, OH (US); Chad Russell WENTLING, West Chester, OH (US)

(21) Appl. No.: 15/510,513

(22) PCT Filed: Jul. 11, 2014
(86) PCT No.: PCT/US2014/046360

§ 371 Date: Mar. 10, 2017

(51) Int. Cl. F02K 1/72; F02K 3/06; F01D 25/24; F02K 1/76

(52) U.S. Cl. CPC F02K 1/72; F02K 1/763; F02K 3/06; F01D 25/24; F05D 2240/50; F05D 2260/53; F05D 2220/323

(57) ABSTRACT

A turbofan engine assembly having a turbine engine and a nacelle that surrounds at least a portion of the turbine engine to define an annular bypass duct that defines a forward-to-aft bypass air flow path. The turbofan engine assembly further comprises a fixed portion and a movable portion which is movable in a direction along the bypass air flow path to an opened position that defines a thrust reversing outlet through which at least a portion of the bypass air flow may be directed. At least one actuator moves the movable portion to the opened position.

### BACKGROUND

Contemporary turbofan aircraft engines may include a thrust reverser system to assist in reducing the aircraft speed during landing. One type of thrust reverser includes a movable portion of the nacelle, often called a translating cowling (a/k/a translating cowl, trans-cowl or transcowl), that when in the reversing position directs airflow through a thrust reverser cascade that reverses at least a portion of the airflow passing through the engine. Typically, the translating cowling moves to the reversing position in response to the force of hydraulic actuators having one end coupled to the engine and another end coupled to the translating cowling, with the translating cowling controlled by a mechanical synchronizing system.

### BRIEF DESCRIPTION

In one aspect, an embodiment of the invention relates to a turbofan engine having a turbine engine and a nacelle surrounding at least a portion of the turbine engine defining an annular bypass duct between the nacelle and the turbine engine and extending through the turbofan engine to define a generally forward-to-aft bypass air flow path. The turbofan engine further comprises a fixed portion and a movable portion which is movable in a direction along the bypass air flow path to an opened position that defines a thrust reversing outlet through which at least a portion of the bypass air flow may be directed. At least one actuator being carried by the movable portion of the nacelle includes a motive force input and a motive force output, which is operably coupled to the fixed portion of the nacelle. Application of a motive force to the motive force input is provided via the motive force output to move the movable portion to the opened position

### BRIEF DESCRIPTION OF THE DRAWINGS

In the drawings:

FIG. 1 is an example schematic side view of a turbofan engine assembly mounted to a wing by a pylon, with a thrust reverser having a movable portion in the form of a trans-cowl in a non-reversing position in accordance with various aspects discussed herein.

FIG. 2 is an example schematic side view of trans-cowl is in the reversing position in accordance with various aspects discussed herein.

FIG. 3 is an example schematic side view of a portion of the thrust reverser in accordance with various aspects discussed herein.

FIG. 4 is an example schematic view of a portion of a thrust reverser in accordance with various aspects discussed herein.

FIG. 5 is an example schematic sectional view in accordance with various aspects discussed herein.

FIG. 6 is an example schematic sectional view in accordance with various aspects discussed herein.

FIG. 7 an example schematic sectional view in accordance with various aspects discussed herein.

FIG. 8 is an example schematic view of the thrust reverser in accordance with various aspects discussed herein.

### DETAILED DESCRIPTION

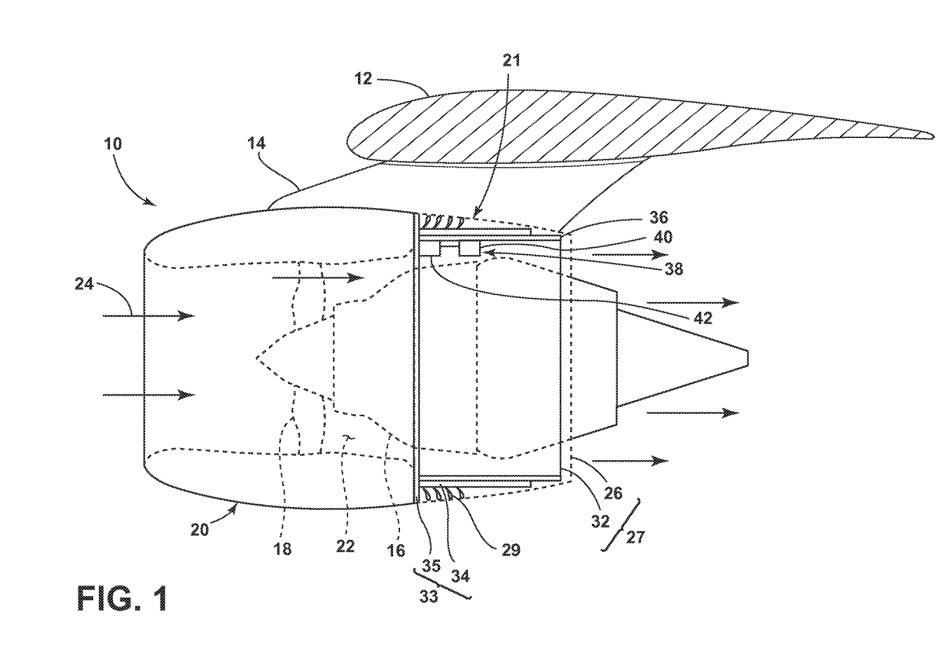

FIG. 1 schematically illustrates an example turbofan engine assembly 10 mounted to the wing 12 of an aircraft by an engine pylon 14. The turbofan engine assembly 10 comprises a turbine engine 16, a fan assembly 18, and a nacelle 20. The nacelle 20 surrounds at least a portion of the turbine engine 16 and defines an annular airflow path or annular bypass duct 22 through the turbofan engine assembly 10 to define a generally forward-to-aft bypass airflow path as schematically illustrated by the arrow 24. A thrust reverser 21 is provided with the turbofan engine assembly 10, and, for the illustrated thrust reverser 21 includes components of the nacelle 20. Portions of the thrust reverser 21 and turbine engine 16 have been shown in phantom for clarity.

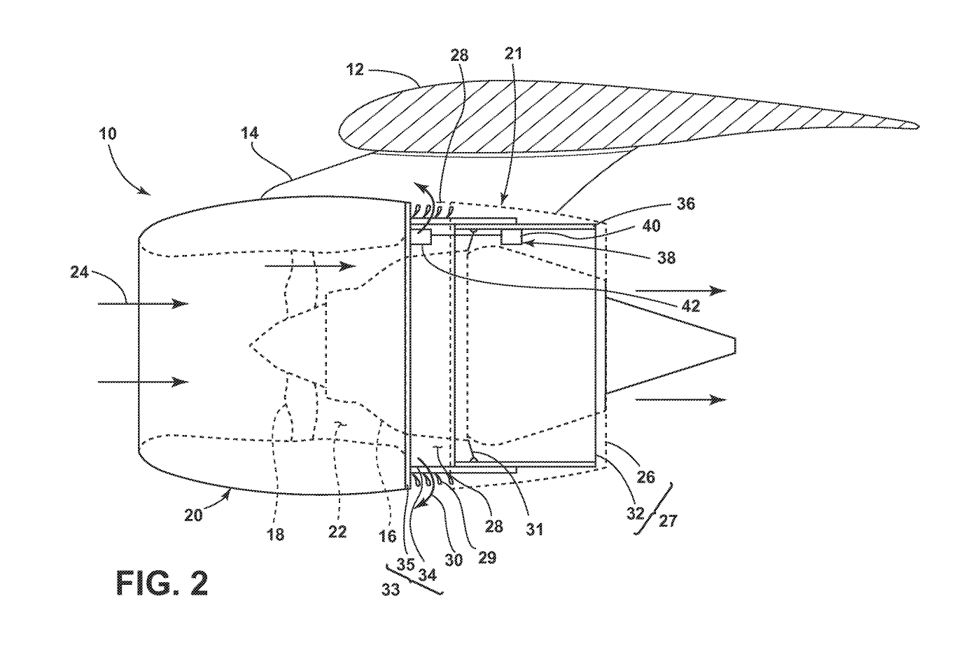

The thrust reverser 21 comprises a fixed portion 33 and movable portion 27 which is movable in the direction along the bypass air flow between a closed position, shown in FIG. 1, and an opened position, shown in FIG. 2. In the illustrated thrust reverser 21, the movable portion 27 comprises an outer translating cowl 26 and an inner translating cowl 32, which collectively may be referred to as a trans-cowl. The outer translating cowl 26 and an inner translating cowl 32 move in unison and may be separate components or integrally formed. The fixed portion 33 comprises a thrust reverser cascade 29, a mounting frame portion and other fixed components of the nacelle 20. The mounting frame portion may comprise an annular mount 35 and a forward-to-aft mounting rail 34.

According to an embodiment of the invention, at least one actuator 38 and at least one guide 36 are mounted between the fixed portion 33 and movable portion 27 of the thrust reverser 21 so as to move and guide the movable portion 27 between the opened and closed positions. The at least one actuator 38 is carried by the movable portion 27 and comprises a motive force input 40 and a motive force output 42. The at least one actuator 38 is carried by the movable portion 27 such that the motive force output 42 is operably coupled to the fixed portion 33 of the thrust reverser 21 and the motive force input 40 is mounted to the movable portion 27 of the thrust reverser.

It will be understood that the thrust reverser 21 may include two separate opposing semicircular inner and outer translating cowls 32, 26 that move in unison, which together, form one circular movable portion 27 or trans-cowl. Each separate inner translating cowl 32 may be provided with one or more actuators 38 as described herein to achieve proper movement of the inner and outer translating cowls 32, 26 to and from an opened position.

FIG. 2 schematically illustrates the example turbofan engine assembly 10 of FIG. 1 with the thrust reverser 21 in the opened position. In the opened position, the inner and outer translating cowls 32, 26 are moved in the aft direction, opening up a gap in the nacelle 20 defining a thrust reversing outlet 28 which exposes the thrust reverser cascade 29 to at least a portion of the bypass airflow. The thrust reverser 21 may also comprise a deflector 31 pivotally mounted to the inner translating cowl 32 that pivots into the annular bypass duct 22 to direct the bypass airflow towards the thrust reverser cascade 29 when the thrust reverser is in the opened position. The thrust reverser 21 changes the direction of the thrust force by directing at least a portion of the bypass airflow through the thrust reverser cascade 29, which has a plurality of vanes that orients at least a portion of the bypass air flow with a rearward direction, resulting in a reversal of at least some of the air flow as illustrated by the arrows 30.

During operation of the at least one actuator 38, a motive force is supplied to the motive force input 40 and is provided via the motive force output 42 to move the movable portion 27 to the opened position. The motive force supplied to the motive force input 40 may vary depending on the type of actuator used. While it is contemplated that the at least one actuator 38 is an electric motor, the at least one actuator 38 may be any suitable type of actuator including but not limited to hydraulic, pneumatic, electrical, or mechanical and the motive force may include but is not limited to a hydraulic force, pneumatic force, electrical force or mechanical force.

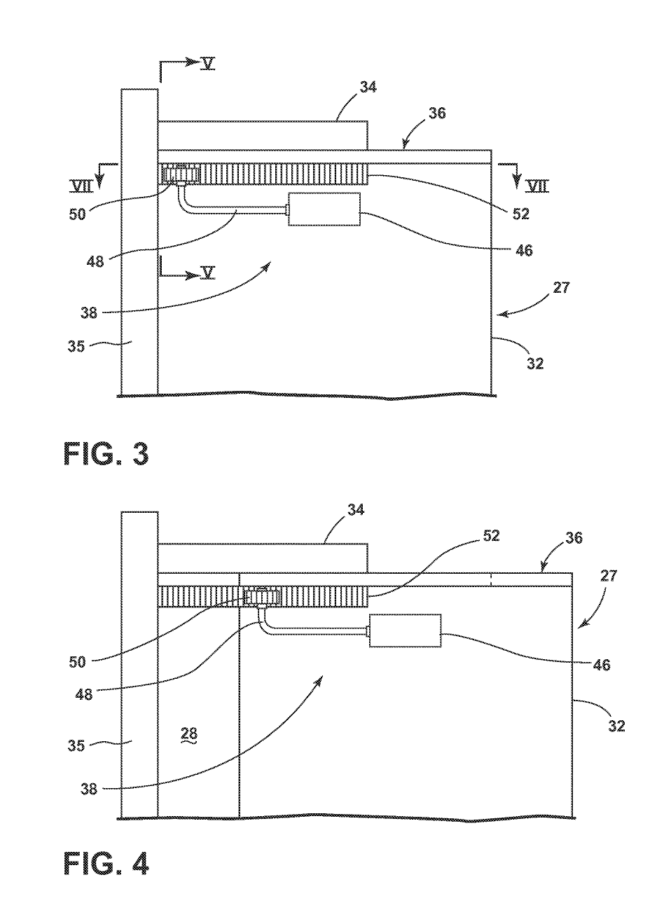

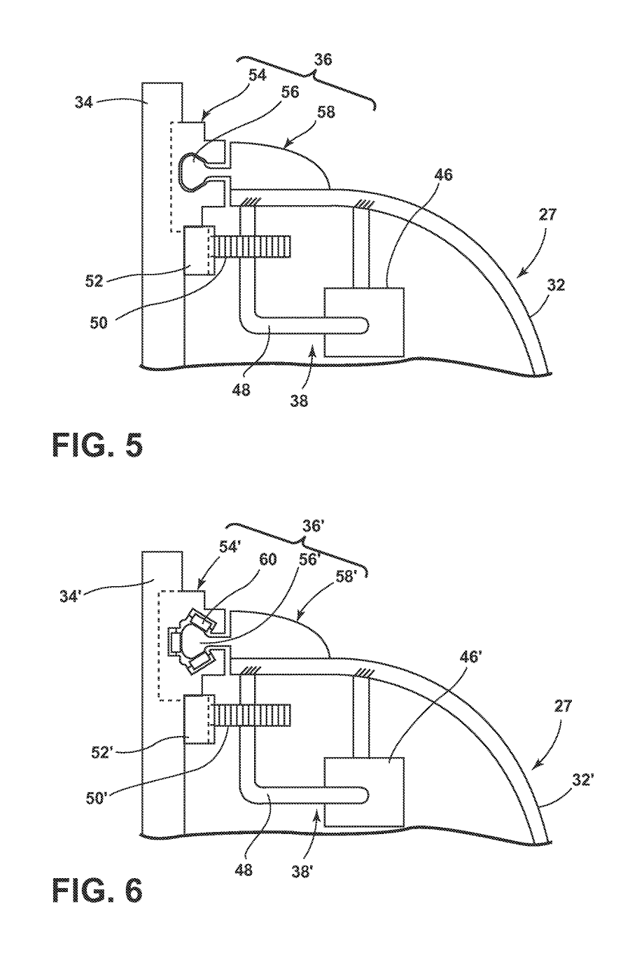

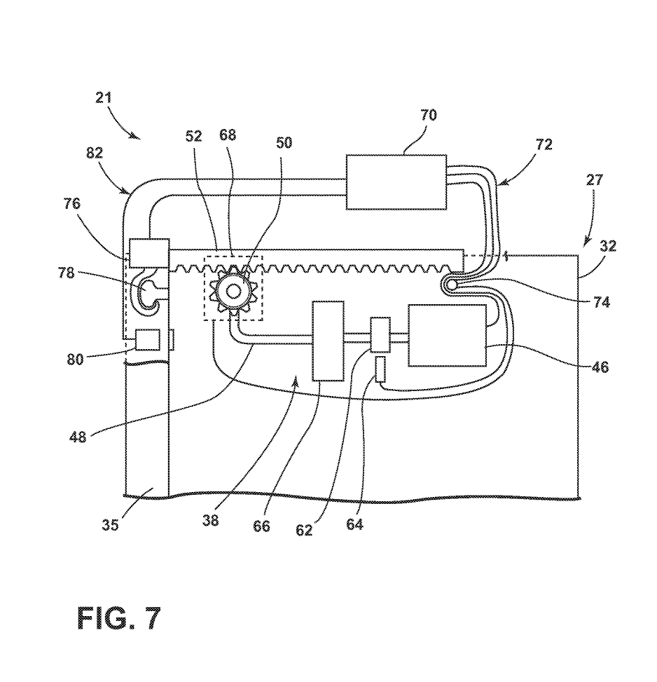

FIG. 3 shows a portion of the thrust reverser of FIG. 1 wherein the at least one actuator 38 comprises an electric motor 46, a flexible drive shaft 48, a pinion gear 50 and a rack 52. The motor 46, defining the motive force input, is connected via a flexible drive shaft 48 to a pinion gear 50 wherein the motor 46 is fixedly mounted to the inner translating cowl 32 (best seen in FIGS. 5 and 6) and the pinion is rotatably mounted to the inner translating cowl 32 (best seen in FIGS. 5 and 6). The pinion meshes with the rack 52, defining the motive force output, which is fixedly mounted to the mounting rail 34 (best seen in FIGS. 5 and 6).

During operation of the at least one actuator 38, an electrical motive force is supplied to the motor 46. The motor converts the electrical force into a rotational mechanical force. The rotational mechanical force is applied to the pinion gear 50 via the flexible drive shaft 48, causing the pinion gear 50 to rotate. As the pinion gear 50 rotates, it travels along the rack 52 in the aft direction. Because the pinion gear 50 and motor 46 are mounted to the inner translating cowl 32 and the rack 52 is mounted the mounting rail 34, the pinion gear 50 traveling along the rack 52 causes the inner translating cowl 32, outer translating cowl (not shown), motor 46 and flexible drive shaft 48 to also travel in the aft direction, away from the annular mount 35. The guide 36 provides for translational movement of the trans-cowl relative the mounting rail 34. In this way, the trans-cowl is moved to the opened position, exposing the thrust revering outlet 28, as shown in FIG. 4.

To move the trans-cowl back to the closed position, the polarity of the electrical motive force may be reversed such that the motor 46 rotates in the opposite direction, causing the pinion gear 50 to travel along the rack 52 in the forward direction toward the annular mount 35.

The guide 36 may comprise a track 54 and a slide 58 as shown in FIG. 5. The track 54 is mounted to or integrally formed with the mounting rail 34. The slide 58 is mounted to the inner translating cowl 32 and comprises a slider 56 that rides inside the track 54. The slider 56 and track 54 are configured to allow for translational movement of the inner translation cowl 32 and outer translating cowl (not shown) while also retaining the slider 56 within the track 54. Both the track 54 and the slide 58 may be made from or coated with low friction material to prevent binding when the inner translating cowl is moved.

Referring to FIG. 6, in an embodiment of the invention where like elements from the previous embodiments are identified with the same reference numerals and include a prime (′) symbol, the track 54′ includes rotatable bearings 60 that communicate with the slider 56′ of the slide 58′. The rotatable bearings 60 are rotatably retained in the track 54′ and configured to provide opposing forces to the slider 56′ to retain the slider 56′ within the track 54′ while providing for translational movement of the inner translation cowl 32′ and outer translating cowl (not shown).

FIG. 7 shows a portion of the thrust reverser of FIG. 3 according to an embodiment of the invention wherein the thrust reverser 21 further comprises a feedback gear 62 and a feedback sensor 64, a gearbox 66, a pinion brake 68, an actuating latch 76 and catch 78, and a proximity sensory 80.

The feedback gear 62 is coupled to the flexible drive shaft 48 between the motor 46 and the pinion gear 50 so that is rotates at a speed corresponding to that of the motor 46, inner translating cowl 32 and the outer translating cowl (not shown). The feedback sensor 64 senses the rotational speed and position of the feedback gear 62 so as to provide a signal indicative of the speed and position of the inner translating cowl 32.

The gearbox 66 is coupled to the flexible drive shaft 48 between the motor 46 and the pinion gear 50 to either reduce or increase the rotation speed of the pinion gear 50, thereby reducing or increasing the speed that the inner translating cowl 32 moves.

The pinion brake 68 is coupled to the pinion gear 50 such that actuation of the pinion brake 68 prevents the pinion gear 50 from rotating. The pinion brake 68 may be any type of brake used to prevent rotation including but not limited to a disk brake, a drum brake or a cone brake.

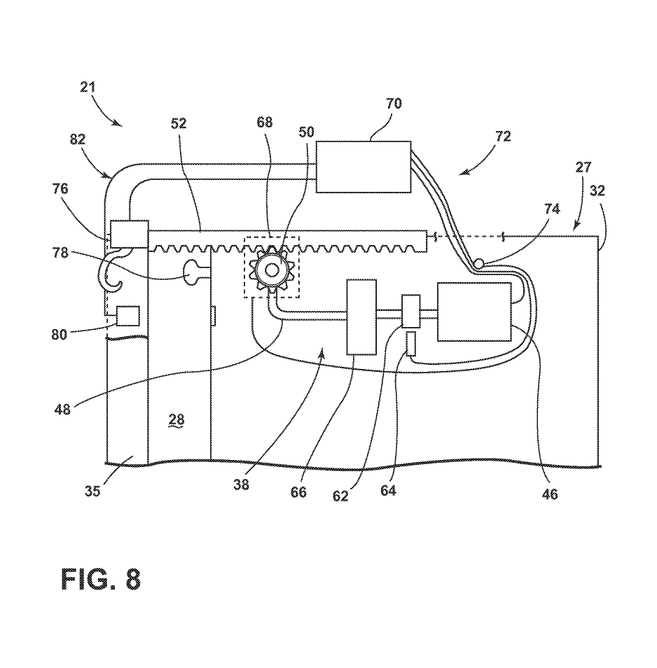

The actuating latch 76 is mounted a fixed portion of the thrust reverser 21, such as the annular mount 35, and is configured to selectively interlock with a catch 78 mounted to the inner translating cowl 32. The actuating latch 76 moves between and interlocking position, as illustrated and a non-interlocking position as shown in FIG. 8. When the actuating latch 76 and catch 78 are interlocked, the inner translating cowl 32 is prevented from moving. Alternatively, the actuating latch 76 may be mounted a movable portion of the thrust reverser 21, such as the inner translating cowl 32 and the catch 78 may be mounted to a fixed portion of the thrust reverser 21, such as the annular mount 35. It will be understood that any locking device could be used in place the actuating latch 76 and catch 78.

The proximity sensor 80 is mounted a fixed portion of the thrust reverser 21, such as the annular mount 35 and is configured to provide a signal when the inner translating cowl 32 is in the closed position. Alternatively, the proximity sensor 80 may be mounted a movable portion of the thrust reverser 21, such as the inner translating cowl 32.

The motor 46, feedback sensor 64, pinion brake 68, actuating latch 76 and proximity sensor 80 may be connected to an electronic engine controller (EEC) 70 provided in or near the turbine engine assembly. The EEC 70 may send and receive signals to and from the proximity sensor 80 and actuating latch 76 through fixed wires 82 to control and monitor the proximity sensor 80 and actuating latch 76.

The EEC may also send and receive signals to and from the motor 46, feedback sensor 64 and pinion brake 68 through movable wires 72 to control and monitor the motor 46, feedback sensor 64 and pinion brake 68. The movable wires 72 may by routed around an accumulator 74 mounted to the inner translating cowl 32 to provide slack in the movable wires 72.

When the inner translating cowl 32 and outer translating cowl (not shown) are moved to the opened position to expose the thrust reversing outlet 28 as shown in FIG. 8, the catch 78, motor 46, feedback gear 62, feedback sensor 64, gearbox 66 flexible driveshaft 48 pinion gear 50, pinion brake 68, accumulator 74 and movable wires 72 move in unison with the inner translation cowl 32. The slack in the movable wires 72 provided by the accumulator 74 ensure that the movable wires 72 maintain connection with the ECC 70 and the components connected thereto.

The embodiments described above provide for a variety of benefits including that the actuator 38 may be integrated with the movable portion 27 of the thrust reverser 21 to save space and provide robust actuation. Also, the motor 46 driven rack 52 and pinion gear 50 allow the inner translating cowl 32 to be moved at any speed. Furthermore, the feedback gear 62 and feedback sensor 64 allows for accurate feedback of the position and speed of the inner translating cowl 32 and outer translating cowl 26 which allows for multiple actuators 38 to be synchronized, thereby eliminating the need for complex synchronization system currently in use.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A turbofan engine assembly comprising:
a turbine engine;
a nacelle assembly surrounding at least a portion of the turbine engine and defining an annular bypass duct between the nacelle and the turbine engine that extends through the turbofan engine assembly to define a generally forward-to-aft bypass air flow path, the nacelle assembly having a fixed portion and a movable portion, which is movable in a direction along the bypass air flow path to an opened position that defines a thrust reversing outlet through which at least a portion of the bypass air flow may be directed; and
at least one actuator being carried by the movable portion of the nacelle and having a motive force input and a motive force output, which is operably coupled to the fixed portion of the nacelle, wherein the application of a motive force to the motive force input is provided by the actuator via the motive force output to move the movable portion to the opened position.

2. The turbofan engine assembly of claim 1 wherein the nacelle comprises a translating cowling forming the movable portion.

3. The turbofan engine assembly of claim 2 wherein the nacelle comprises a frame portion forming the fixed portion.

4. The turbofan engine assembly of claim 3 wherein the at least one actuator comprises a rack and pinion gear, which is meshed with the rack.

5. The turbofan engine assembly of claim 4 wherein the rack is carried by the frame and the pinion gear is carried by the translating cowling.

6. The turbofan engine assembly of claim 5 wherein the rack is fixedly mounted to the frame.

7. The turbofan engine assembly of claim 6 wherein the pinion gear is rotatably mounted to the translating cowling.

8. The turbofan assembly engine of claim 7 wherein the pinion gear transfers the motive force output to the rack.

9. The turbofan engine assembly of claim 8 wherein the at least one actuator further comprises an electric motor drivingly coupled to the pinion gear, wherein the motive force input effects the rotation of the electric motor, which provides a motive force output to rotate the pinion gear.

10. The turbofan engine assembly of claim 9 wherein the electric motor is provided on the translating cowling.

11. The turbofan engine assembly of claim 10 wherein the electric motor is fixedly mounted to the translating cowling.

12. The turbofan engine assembly of claim 3 wherein the nacelle comprises a guide having a track and a slide.

13. The turbofan engine assembly of claim 12 wherein the track is provided on the frame and the slide is provided on the translating cowling.

14. The turbofan engine assembly of claim 13 wherein the track comprises rotating bearings.
